(19) United States
(12) Patent Application Publication
(10) Pub. No.: US 2026/0217022 A1
(43) Pub. Date: Jul. 30, 2026

(54) LIQUID DISCHARGE APPARATUS AND LIQUID DISCHARGE METHOD

(71) Applicant: Osamu MACHIDA, Kanagawa (JP)

(72) Inventor: Osamu MACHIDA, Kanagawa (JP)

(21) Appl. No.: 19/143,438

(22) PCT Filed: Feb. 16, 2024
(86) PCT No.: PCT/IB2024/051473

§ 371 Date: Jun. 26, 2025

(30) Foreign Application Priority Data
Mar. 1, 2023 (JP) 2023-031056
Jan. 16, 2024 (JP) 2024-004712

(51) Int. Cl. B41J 2/045; B41J 2/14

(52) U.S. Cl. CPC B41J 2/04593; B41J 2/04541; B41J 2/04581; B41J 2/04588; B41J 2/14233

(57) ABSTRACT

A liquid discharge apparatus includes a substrate having a pressure chamber, an actuator forming layer, and a signal generator. The actuator forming layer includes a nozzle forming portion having a nozzle from which a liquid in the pressure chamber is dischargeable, an actuator including an annular piezoelectric body disposed around the nozzle, a diaphragm holding the actuator. The signal generator generates a drive signal including multiple unit pulses in a predetermined period, applies the multiple unit pulses to the actuator to vibrate the actuator forming layer to discharge multiple liquid droplets from the nozzle and merge the multiple liquid droplets to form one liquid droplet, and varies a number of the multiple unit pulses continuously applied to the actuator to vary an amount of the one liquid droplet discharged from the nozzle. Each of the multiple unit pulses has start and end electric potentials equal to each other.

### TECHNICAL FIELD

Embodiments of the present disclosure relate to a liquid discharge apparatus and a liquid discharge method.

### BACKGROUND ART

A liquid discharge head of a nozzle vibration type is known in the art. The liquid discharge head may be referred to as an inkjet head. In the nozzle vibration type, a nozzle of the liquid discharge head is vibrated to discharge a liquid. The liquid discharge head of the nozzle vibration type can be manufactured with simple structure, low cost, and high density.

The liquid discharge head of the nozzle vibration type is suitable for multi-waveform drive in which a drive waveform is continuously applied to the liquid discharge head so as to discharge a liquid by resonance to form droplets of the liquid. In the multi-waveform drive, a relatively simple waveform is repeated to widen the variable range of the amount of droplets. For example, PTL 1 discloses a technique of a multi-drop drive method in which the number of droplets of ink to be discharged to form one dot varies without changing the size of the droplets of ink to adjust density gradation. However, PTL 1 describes the technique related to an inkjet head of a type in which a nozzle and a diaphragm are disposed apart from each other, which is different from the nozzle vibration type, and thus the technique does not fit the characteristics of the nozzle vibration type.

### CITATION LIST

### Patent Literature

### PTL 1

Japanese Unexamined Patent Application Publication No. 2007-022073

### SUMMARY OF INVENTION

### Technical Problem

The present disclosure has an object to provide a stable driving system by the variable amount of liquid droplets by multi-drop in a liquid discharge head of a nozzle vibration type or a liquid discharge apparatus including the liquid discharge head.

### Solution to Problem

A liquid discharge apparatus includes a substrate having a pressure chamber, an actuator forming layer, and a signal generator. The actuator forming layer includes a nozzle forming portion having a nozzle from which a liquid in the pressure chamber is dischargeable, an actuator including an annular piezoelectric body disposed around the nozzle, a diaphragm holding the actuator. The signal generator generates a drive signal including multiple unit pulses in a predetermined period, applies the multiple unit pulses of the drive signal to the actuator to vibrate the actuator forming layer to discharge multiple liquid droplets from the nozzle and merge the multiple liquid droplets to form one liquid droplet, and varies a number of the multiple unit pulses continuously applied to the actuator to vary an amount of the one liquid droplet discharged from the nozzle. Each of the multiple unit pulses has a start electric potential and an end electric potential equal to the start electric potential.

According to another embodiment of the present disclosure, there is provided a liquid discharge method including generating a drive signal including multiple unit pulses, applying the multiple unit pulses of the drive signal to an actuator of a liquid discharge head to discharge multiple liquid droplets from a nozzle of the liquid discharge head and merge the multiple liquid droplets to form one liquid droplet, and varying a number of the multiple unit pulses continuously applied to the actuator to vary an amount of the one liquid droplet discharged from the nozzle. Each of the multiple unit pulses has a start electric potential and an end electric potential equal to the start electric potential.

### Advantageous Effects of Invention

According to one aspect of the present disclosure, in the liquid discharge head of the nozzle vibration type or the liquid discharge apparatus including the liquid discharge head, the stable driving system can be provided by changing the amount of liquid droplets by multi-drop.

### BRIEF DESCRIPTION OF DRAWINGS

A more complete appreciation of the embodiments and many of the attendant advantages and features thereof can be readily obtained and understood from the following detailed description with reference to the accompanying drawings

FIG. 1 is a schematic cross-sectional view of a liquid discharge head of a nozzle vibration type according to an embodiment of the present disclosure.

FIG. 2 is a schematic perspective view of the liquid discharge head of FIG. 1.

FIG. 3 is an enlarged cross-sectional view of a portion X of the liquid discharge head of FIG. 1.

FIG. 4A is a schematic diagram illustrating the movement of a diaphragm when the liquid discharge head of FIG. 1 discharges liquid from a nozzle to form a liquid droplet.

FIG. 4B is a graph illustrating a drive waveform when the liquid discharge head of FIG. 1 discharges liquid from a nozzle to form a liquid droplet.

FIG. 5A is a schematic diagram illustrating another movement of the diaphragm when the liquid discharge head of FIG. 1 discharges liquid from a nozzle to form a liquid droplet, according to an alternative embodiment of the present disclosure.

FIG. 5B is a graph illustrating another drive waveform when the liquid discharge head of FIG. 1 discharges liquid from a nozzle to form a liquid droplet, according to an alternative embodiment of the present disclosure.

FIG. 6 is a diagram illustrating a line printed by multi-waveform drive according to an embodiment of the present disclosure.

FIG. 7 is a schematic diagram illustrating multiple liquid droplets which are discharged from a liquid discharge head according to an embodiment of the present disclosure, and fly and coalesce into a single liquid droplet.

FIG. 8 is a schematic diagram illustrating a liquid droplet which is discharged from a liquid discharge head according to a comparative example and flies.

FIG. 9 is a graph of a drive signal in which the waveform of one unit pulse is a sine wave, according to an embodiment of the present disclosure.

FIG. 10 is a graph of a drive signal including three unit pulses of a simple sine wave to be applied, according to an embodiment of the present disclosure.

FIG. 11 is a graph of a drive signal including three unit waveforms of a square wave to be applied, according to an embodiment of the present disclosure.

FIG. 12 is a graph of a drive signal including four unit waveforms of a trapezoidal wave to be applied, according to an embodiment of the present disclosure.

FIG. 13 is a graph of a drive signal including a drive waveform having unit waveforms in each of which the voltage is variable, according to an embodiment of the present disclosure.

FIG. 14 is a set of graphs illustrating the relation between the number of pulses and the volume of liquid droplets when one unit pulse is continuously applied, according to an embodiment of the present disclosure.

FIG. 15 is a graph of a drive signal including a drive waveform in which a start electric potential is 0 V and an end electric potential is 0 V, according to an embodiment of the

FIG. 16 is a graph of a drive signal including a drive waveform in which a start electric potential is positive, an end electric potential is positive, and an electric potential at any point of the drive waveform is positive larger than 0 V, according to an embodiment of the present disclosure.

FIG. 17 is a graph of a drive signal including a drive waveform in which a start electric potential is negative, an end electric potential is negative, and an electric potential at any point of the drive waveform is negative smaller than 0 V, according to an embodiment of the present disclosure.

FIG. 18A is a schematic diagram illustrating the movement of the diaphragm when the drive waveform of FIG. 13 is applied to the liquid discharge head of FIG. 1.

FIG. 18B is a graph illustrating the drive waveform of FIG. 13.

FIG. 19A is a schematic diagram illustrating the movement of the diaphragm when the drive waveform of FIG. 15 is applied to the liquid discharge head of FIG. 1.

FIG. 19B is a graph illustrating the drive waveform of FIG. 15.

FIG. 20A is a schematic diagram illustrating the movement of the diaphragm when the drive waveform of FIG. 16 is applied to the liquid discharge head of FIG. 1.

FIG. 20B is a graph illustrating the drive waveform of FIG. 16.

FIG. 21A is a schematic diagram illustrating the movement of the diaphragm when the drive waveform of FIG. 17 is applied to the liquid discharge head of FIG. 1.

FIG. 21B is a graph illustrating the drive waveform of FIG. 17.

FIGS. 22A to 22C are diagrams each illustrating the shape of one unit pulse according to an embodiment of the present disclosure.

FIG. 23 is a block diagram illustrating a hardware configuration of a control system of an inkjet recording apparatus including a head unit according to an embodiment of the present disclosure.

FIG. 24 is a schematic view of a liquid discharge apparatus according to an embodiment of

FIG. 25 is a plan view of a head unit of the liquid discharge apparatus of FIG. 24.

FIG. 26 is a schematic plan view of a part of a liquid discharge apparatus according to another embodiment of the present disclosure.

FIG. 27 is a schematic side view of the part of the liquid discharge apparatus of FIG. 26.

FIG. 28 is a schematic plan view of a part of a liquid discharge unit according to an embodiment of the present disclosure.

FIG. 29 is a schematic front view of a liquid discharge unit according to another embodiment of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise.

Embodiments of the present disclosure are described below with reference to the attached drawings. In the drawings for illustrating embodiments of the present disclosure, like elements or like components in function or shape are given like reference signs as far as distinguishable, and overlapping descriptions may be omitted.

A liquid discharge head of a liquid discharge apparatus according to an embodiment of the present disclosure is described below.

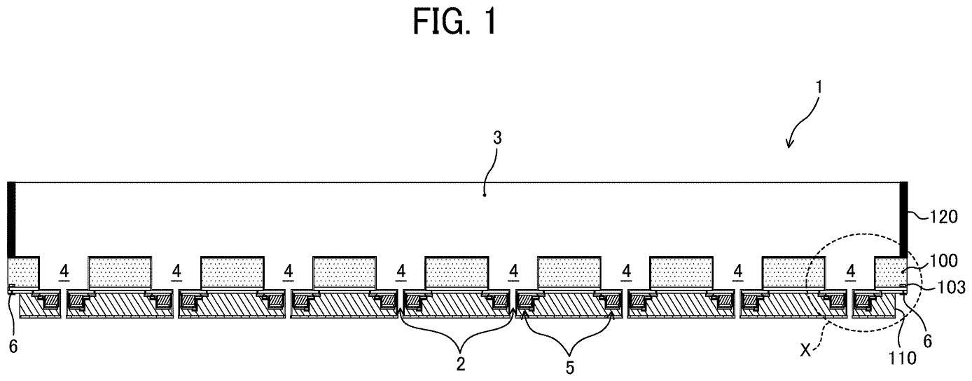

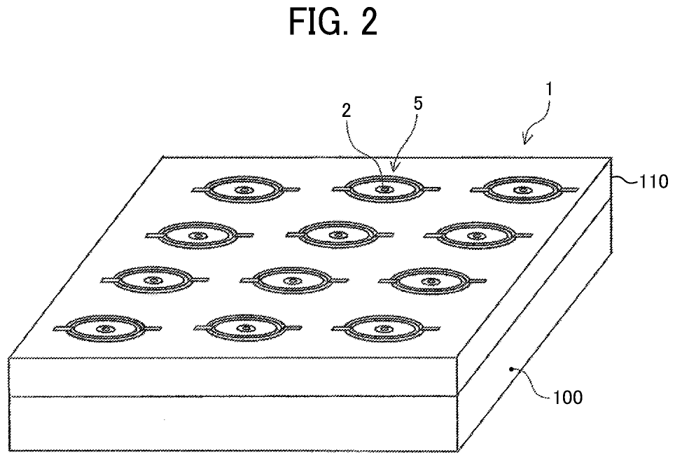

FIG. 1 is a schematic cross-sectional view of a liquid discharge head of a nozzle vibration type according to an embodiment of the present disclosure. FIG. 2 is a schematic perspective view of the liquid discharge head of FIG. 1.

A liquid discharge head 1 according to the present embodiment includes an actuator forming layer 110, a channel substrate 100, and a frame 120.

The actuator forming layer 110 is a thin film and includes a vibration film 103, multiple nozzles 2, and piezoelectric elements 5. The vibration film 103 may be referred to as a diaphragm. A liquid is discharged from the multiple nozzles 2. The piezoelectric element 5 is annular and disposed around each of the multiple nozzles 2. The channel substrate 100 has multiple pressurization chambers 4, which may be referred to as “individual liquid chambers” or “pressure chambers.” The multiple pressurization chambers 4 communicate with the multiple nozzles 2, respectively. The frame 120 has a common liquid chamber 3 communicating with the multiple pressurization chambers 4.

The electrical connection pads 6 to be connected to an electrical component such as an external power source are disposed at both ends of the liquid discharge head 1.

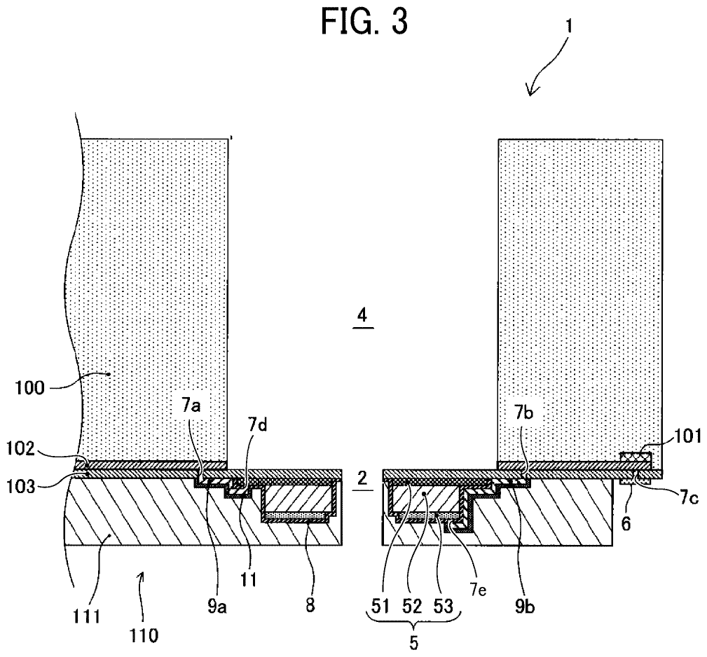

FIG. 3 is an enlarged cross-sectional view of a portion X of the liquid discharge head of FIG. 1.

The channel substrate 100 is a silicon on insulator (SOI) substrate. The channel substrate 100 includes a drive circuit 101 and a wiring 102 on a side on which the vibration film 103 is formed. The drive circuit 101 includes, for example, a transistor and a resistor. The wiring 102 includes the wiring for applying a voltage to a first electrode 51 and the wiring for applying a voltage to a second electrode 53. The wiring 102 is electrically connected to the electrical connection pad 6 through a third contact 7c opened in the vibration film 103.

The actuator forming layer 110 includes a nozzle forming portion (film) 111. The multiple nozzles 2 are formed in the nozzle forming portion 111, and the piezoelectric element 5 is covered with the nozzle forming portion 111. A liquid-repellent film may be formed on a nozzle face of the nozzle forming portion 111. The liquid repellent film on the nozzle face prevents liquid from adhering to the nozzle face. Accordingly, liquid discharged from the nozzle 2 is not affected by the liquid adhering to the nozzle face. When the solvent of the liquid is aqueous, perfluorodecyltrichlorosilane or perfluorooctyltrichlorosilane can be used as the material of the liquid-repellent film.

The piezoelectric element 5 of the actuator forming layer 110 includes the first electrode 51, a piezoelectric film 52, and the second electrode 53. The first electrode 51 may be referred to as a lower electrode, the piezoelectric film 52 may be referred to as a piezoelectric body, and the second electrode 53 may be referred to as an upper electrode. The piezoelectric element 5 is covered with an insulating film 8.

The insulating film 8 has a hole-shaped fourth contact 7d through which the first electrode 51 and a first lead 9a are electrically connected, and a hole-shaped fifth contact 7e through which the second electrode 53 and a second lead 9b are electrically connected. The first lead 9a is disposed on the insulating film 8 to electrically connect the first electrode 51 of the piezoelectric element 5 and the wiring 102 of the channel substrate 100. The second lead 9b is disposed on the insulating film 8 to electrically connect the second electrode 53 of the piezoelectric element 5 and the wiring 102 of the channel substrate 100.

The first lead 9a is electrically connected to the first electrodes 51 through the fourth contact 7d and to the wiring 102 through a first contact 7a. The second lead 9b is electrically connected to the second electrode 53 through the fifth contact 7e and to the wiring 102 through a second contact 7b.

The first lead 9a and the second lead 9b are covered with a moisture-proof film 11. Due to such a configuration, moisture may permeate through the nozzle forming portion 111 made of resin but does not reach the first lead 9a and the second lead 9b. As a result, corrosion of the first lead 9a and the second lead 9b can be prevented.

The moisture-proof film 11 preferably has an electrical insulation property. Since the moisture-proof film 11 has two functions including electrical insulation and moisture-proof properties, the actuator forming layer 110 can be thinned compared to when an insulating film is separately formed under the moisture-proof film 11. Such a configuration facilitates the deformation of the vibration film 103, and enhances vibration efficiency.

For example, silicon nitride (SiN), which is common in a moisture-proof film for a semiconductor, is preferable as the moisture-proof film 11 so that the moisture-proof film 11 can have two functions including electrical insulation and moisture-proof properties. In addition to SiN, examples of the material of the moisture-proof film 11 include oxides of aluminum (Al), tantalum (Ta), niobium (Nb), titanium (Ti), hafnium (Hf), zirconium (Zr), and tungsten (W), which can be easily formed in a dense film by atomic layer deposition (ALD).

The liquid discharge head 1 described in the above embodiment is the nozzle vibration type. The liquid discharge head 1 of the nozzle vibration type includes a liquid discharge mechanism in which a driving source (i.e., the piezoelectric element 5) is disposed in a film (i.e., the nozzle forming portion 111) at the front end of the liquid discharge head 1. The driving source is driven by multi-waveform drive to discharge liquid. The liquid discharge head 1 discharges the liquid in the pressurization chamber 4 from the nozzle 2 by the multi-waveform drive to output multiple liquid droplets (multi-drop). At this time, the liquid discharge head 1 changes (varies) the number of pulses in the drive signal to be applied so as to change (varies) the number of liquid droplets to be discharged to control the amount of the coalescing liquid droplets to be output by a variable-size droplet method with multi-drop.

In embodiments of the present disclosure, for example, a liquid discharge apparatus including a liquid discharge head of the nozzle vibration type performs the variable-size droplet method with multi-drop with the following configuration.

The liquid discharge apparatus according to an embodiment of the present disclosure includes a substrate (e.g., the channel substrate 100) having a pressure chamber (e.g., the pressurization chamber 4), a nozzle (e.g., the nozzle 2) from which a liquid in the pressure chamber is discharged, an actuator (e.g., the piezoelectric element 5) including a piezoelectric body (e.g., the piezoelectric film 52) to discharge the liquid from the nozzle to form a liquid droplet, a diaphragm (e.g., the vibration film 103) holding the actuator, and a signal generator (e.g., the drive circuit 101). The liquid discharge head changes the position of the diaphragm (i.e., displaces the diaphragm) to drive the nozzle to discharge the liquid.

The name and the reference numeral in parentheses correspond to the configuration illustrated in FIGS. 1 to 3.

The signal generator generates a drive signal including continuous multiple unit pulses. The amount of liquid droplets to be output changes in response to the number of unit pulses. The signal generator generates a signal (drive waveform) so as to, for example, change the position of the diaphragm to drive the nozzle to discharge a liquid (i.e., displace the diaphragm to vibrate the nozzle forming portion (the actuator forming layer 110) to discharge the liquid from the nozzle).

In the present embodiment, the “one unit pulse” is a pulse having a start electric potential and an end electric potential equal to the start electric potential to cause the liquid in the pressure chamber to be discharged from the nozzle to form (output) one liquid droplet. The waveform of one unit pulse is also referred to as a “unit waveform.”

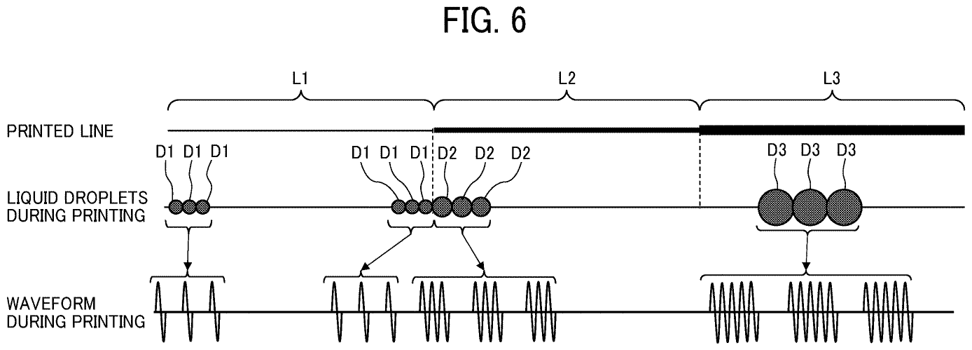

The amount of liquid droplets is an amount (e.g., volume, weight, and size) of one or more liquid droplets coalescing into a single droplet. The coalescing droplets reach a recording medium at one desired position to form one dot on the recording medium. The amount of liquid droplets is described later with reference to FIGS. 6 to 8.

The “start electric potential” is the voltage at the start of the vibration of the nozzle forming portion.

The “end electric potential” is the voltage at which the nozzle forming portion returns to the position before the vibration.

The liquid discharge head 1 having the above-described configuration can perform the multi-waveform drive with repeating simple waveforms, as compared with a liquid discharge head according to a comparative example, in which a nozzle and a diaphragm are disposed apart from each other. Accordingly, the amount of liquid droplets can be changed in a wide range to increase the range of the variable amount of liquid droplets.

The liquid discharge head of the nozzle vibration type can set a desired voltage of the drive waveform. Accordingly, the liquid discharge head can efficiently discharge liquid with an inexpensive power source. In addition, the liquid discharge head of the nozzle vibration type can set a desired reference voltage. Accordingly, the liquid discharge head can choose a power source from a wider range of power sources and can stably discharge liquid at low cost.

As a result, the liquid discharge head according to the present embodiment or a liquid discharge apparatus including the liquid discharge head can provide a stable driving system. The details are described below.

A state of the nozzle 2 driven in the liquid discharge head 1 of the nozzle vibration type according to the present embodiment is described below.

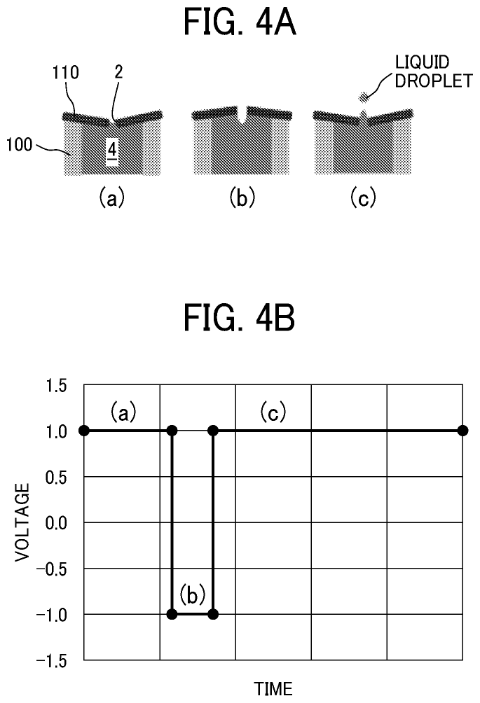

FIGS. 4A and 4B illustrate the relation between the movement of the diaphragm and the drive waveform when the liquid discharge head 1 discharges liquid from the nozzle 2 to form a liquid droplet, according to the present embodiment. FIG. 4A is a schematic diagram illustrating the movement of the diaphragm, and FIG. 4B is a graph of the drive waveform according to the present embodiment.

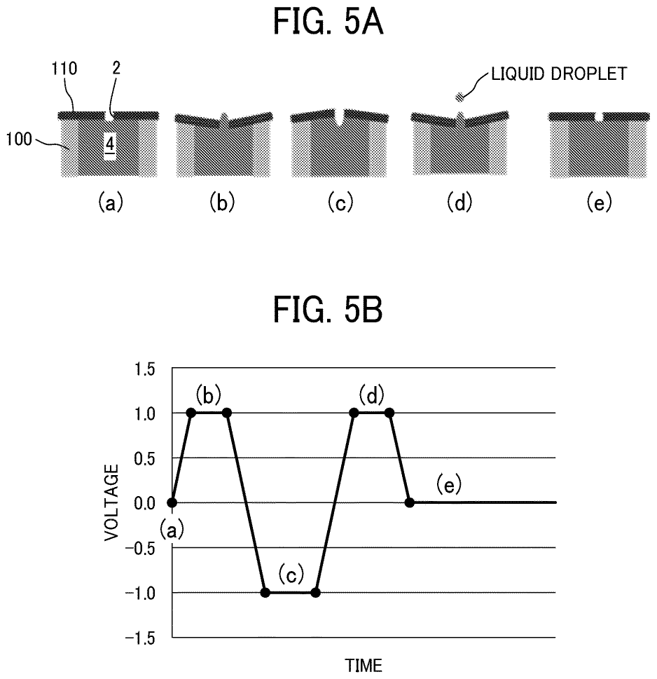

The states of the diaphragm of the actuator forming layer 110 illustrated in states (a) to (c) of FIG. 4A correspond to time ranges (a) to (c) of the applied drive waveform illustrated in FIG. 4B. For example, the diaphragm moves as illustrated in the state (a) of FIG. 4A in the time range (a) of the applied drive waveform illustrated in FIG. 4B. FIG. 4A schematically illustrates the movement of the actuator forming layer 110. Specifically, FIG. 4A schematically illustrates the movement of the diaphragm (e.g., the vibration film 103) changed (displaced) by the piezoelectric element 5 driven by the drive circuit 101. The same applies to, for example, FIGS. 5A and 5B and FIGS. 18A to 21B which illustrate the relation between the movement of the diaphragm and the drive waveform, which are described later.

In FIGS. 4A and 4B, the volume of the pressurization chamber 4 when a high electric potential is applied is smaller than the volume of the pressurization chamber 4 when a low electric potential lower than the high electric potential is applied.

The diaphragm changes (deforms) so as to decrease the volume of the pressurization chamber 4 when the drive voltage rises (i.e., a rising edge of the drive signal), and changes (deforms) so as to increase the volume of the pressurization chamber 4 when the drive voltage falls (i.e., a falling edge of the drive signal). The liquid discharge head 1 discharges liquid from the nozzle 2 to form a liquid droplet when the drive voltage rises.

The liquid discharge head 1 is of the nozzle vibration type, and the nozzle 2 of the liquid discharge head 1 is driven to discharge a liquid droplet. Accordingly, the discharged liquid droplet separates from the nozzle 2 immediately after the discharge, and a mist is less likely to be generated. For this reason, the interval between multiple pulses can be shortened as compared with a liquid discharge head other than the nozzle vibration type. As a result, the range of the variable amount of liquid droplets can be increased.

Specifically, for example, one unit pulse can be 5 microseconds (us) or less. The drive frequency of the liquid discharge head other than the nozzle vibration type was about 30 kHz to change the amount of liquid droplets, but the drive frequency of the liquid discharge head of the nozzle vibration type was 100 kHz to change the amount of liquid droplets in experiments.

FIG. 5A is a schematic diagram illustrating another movement of the diaphragm when the liquid discharge head 1 discharges liquid from the nozzle 2 to form a liquid droplet, according to an alternative embodiment of the present disclosure. FIG. 5B is a graph illustrating another drive waveform when the liquid discharge head 1 discharges the liquid from the nozzle 2 to form the liquid droplet, according to an alternative embodiment of the present disclosure. In FIGS. 5A and 5B, the drive waveform in the time ranges (a) and (b) of FIG. 5B is applied to the liquid discharge head 1 to preliminary vibrate the diaphragm before the discharge.

Accordingly, the first displacement (deformation) of the diaphragm (i.e., the displacement from the state (a) to the state (b) of FIG. 5A) vibrates the meniscus of liquid in the nozzle 2.

As a result, the liquid discharge head 1 can more efficiently discharge a liquid droplet. The mist is less likely to be generated due to the relation between the meniscus in the nozzle 2 and the deformation speed of the nozzle 2 (the nozzle forming portion 111).

An image of printing by multiple waveforms, which may be referred to as the “multiple pulses,” is described below with reference to FIG. 6.

FIG. 6 is a diagram illustrating a line printed by the multi-waveform drive according to the present embodiment.

FIG. 6 illustrates a printed line in the upper part, liquid droplets at the time of printing in the middle part, and a drive waveform at the time of printing in the lower part.

The upper part of FIG. 6 illustrates printed lines L1, L2, and L3 having, for example, three different thicknesses. The lines L1, L2, and L3 become thicker in this order (thickness: L1<L2 21 L3).

The middle part of FIG. 6 illustrates the size of the liquid droplets forming the lines in the upper part. Liquid droplets D1, D2, and D3 correspond to the lines L1, L2, and L3, respectively. The points at which the thickness of the lines L1, L2, and L3 changes in the upper part are associated with the points at which the size of the liquid droplets changes in the middle part by broken lines.

The lower part of FIG. 6 illustrates multiple waveforms for forming the liquid droplets illustrated in the middle part. In FIG. 6, one unit pulse is, for example, a sin wave pulse. The liquid droplet D1 is one liquid droplet output from the nozzle 2 when one unit pulse is applied to the piezoelectric body. The liquid droplet D1 has the amount of the one liquid droplet formed by the one unit pulse.

The liquid droplet D2 is three liquid droplets, which are output from the nozzle 2 when three unit pulses are applied to the piezoelectric body, coalescing into one. The liquid droplet D2 has three times the amount of one liquid droplet formed by one unit pulse.

The liquid droplet D3 is five liquid droplets, which are output from the nozzle 2 when five unit pulses are applied to the piezoelectric body, coalescing into one. The liquid droplet D3 has five times the amount of one liquid droplet formed by one unit pulse.

As described above, the signal generator changes (varies) the number of unit pulses to be continuously applied to the piezoelectric body to change (varies) the amount of liquid droplets to be output.

The amount of liquid droplets may be represented by, for example, size (area) as illustrated in FIG. 6, or may be represented by volume or weight. The amount of liquid droplets may be referred to as a “droplet volume” when expressed by volume, and as a “droplet weight” when expressed by weight.

The process of coalescence (combination) of multiple liquid droplets discharged from the liquid discharge head is described below.

The multiple liquid droplets formed by the multi-waveform drive fly toward the recording medium. At this time, the liquid droplets have little tailing. Even when one unit pulse is repeatedly applied multiple times with a short period, the individual liquid droplets separately fly, and the multiple liquid droplets coalesce (are merged) into a single liquid droplet (for example, the liquid droplet D2 or D3 in FIG. 6). Then, the coalescing liquid droplet reaches the recording medium.

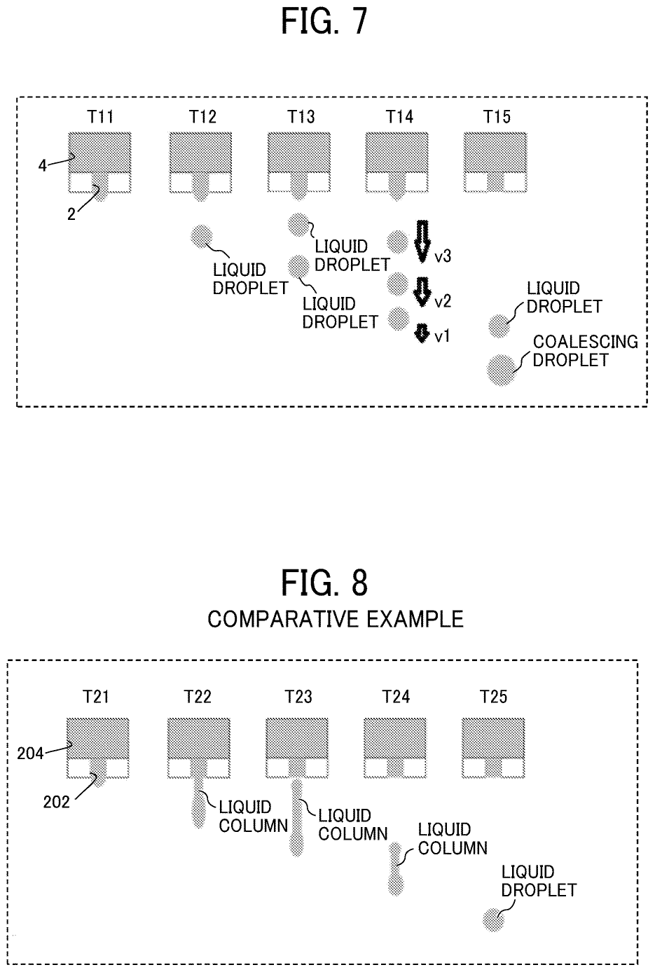

FIG. 7 illustrates multiple liquid droplets which are discharged by the multiple unit pulses from the liquid discharge head of the nozzle vibration type according to the present embodiment, and fly and coalesce into a single liquid droplet.

FIG. 8 illustrates a liquid droplet which is discharged from a liquid discharge head other than the nozzle vibration type according to a comparative example and flies.

In FIGS. 7 and 8, time elapses from left to right, for example, from times T11 and T21 to times T15 and T25, respectively.

Since the liquid droplet discharged from the liquid discharge head 1 driven by resonance has little tailing, the liquid discharge head 1 according to the present embodiment can repeatedly apply multiple pulses with a short period. For example, when the liquid in the pressurization chamber 4 is discharged from the nozzle 2 (the time T11), the discharged liquid forms a liquid droplet immediately after the discharge, and the liquid droplet separates from the nozzle 2 and flies without tailing (the time T12). Accordingly, the liquid discharge head 1 can advance the point in time to discharge the next liquid droplet (the times T13 and T14). For example, two unit pulses have been applied and two liquid droplets have been formed at the time T13, and three unit pulses have been applied and three liquid droplets have been formed at the time T14. As described above, the multi-waveform drive according to the present embodiment can increase the range of the variable amount of liquid droplets according to the number of repeated pulses.

Further, since the displacement amount of the diaphragm gradually increases, the velocity of the liquid droplet increases for each repetition, and the latter liquid droplet catches up with the former liquid droplet output previously and coalesces into a single liquid droplet.

At the time T14, a velocity v3 of the third liquid droplet output next to the second liquid droplet is faster than a velocity v2 of the second liquid droplet, and the velocity v2 of the second liquid droplet output next to the first liquid droplet is faster than a velocity v1 of the first liquid droplet as illustrated in FIG. 7 (i.e., v1<v2<v3). At the time T15, some of the multiple liquid droplets coalesce into a single liquid droplet.

On the other hand, the liquid discharge head according to the comparative example is a liquid discharge head that is not of the nozzle vibration type. A liquid droplet, which is discharged from a nozzle 202 of the liquid discharge head according to the comparative example, has a longer tailing than the liquid droplet discharged from the liquid discharge head 1 according to the present embodiment.

For example, when the liquid in a pressurization chamber 204 is discharged from the nozzle 202 (the time T21), the discharged liquid forms a liquid column without separating from the nozzle 202 (the time T22). The liquid column separates from the nozzle 202 after becoming longer (the time T23). Then, the liquid column becomes short (the time T24), and a liquid droplet is formed when a predetermined time has elapsed (the time T25). Accordingly, it is difficult to apply multiple pulses with a short period. As described above, it is difficult for the liquid discharge head according to the comparative example to increase the amount of liquid droplets as compared with the liquid discharge head according to the present embodiment. In the present embodiment, the short period is, for example, several to several hundred microseconds (μs), and continuous multiple pulses are applied within a predetermined period. The predetermined period may be determined in advance based on, for example, a resonance frequency of the pressurization chamber 4.

As described above, the liquid droplet discharged from the liquid discharge head 1 of the nozzle vibration type driven with the resonance frequency of the pressurization chamber 4 has shorter tailing than the liquid droplet discharged from the liquid discharge head according to the comparative example. As a result, multiple pulses can be repeatedly applied with a short period. Accordingly, the range of the variable amount of liquid droplets corresponding to the number of pulses of the repeated unit pulses can be increased.

Since the liquid discharge head of the nozzle vibration type has a higher discharge efficiency than the liquid discharge head according to the comparative example, the piezoelectric body for driving the diaphragm can be selected from a wider range of materials.

For example, the liquid discharge head according to the comparative example uses lead zirconate titanate (PZT), which is a ferroelectric material, as the piezoelectric body to obtain a large displacement amount of the diaphragm. Since PZT is polarized, the liquid discharge head according to the comparative example uses either a positive or negative electric field, which may be referred to as a “unipolar electric field.”

On the other hand, the liquid discharge head of the nozzle vibration type having the high drive efficiency of the diaphragm can use a material other than the ferroelectric material such as PZT. Accordingly, the liquid discharge head of the nozzle vibration type can be driven using both positive and negative electric fields, which may be referred to as “bipolar electric fields.” As a result, the liquid discharge head of the nozzle vibration type can be stably driven with an inexpensive power source having a maximum voltage lower than that of the unipolar electric field.

Specific examples of the drive signal generated by the signal generator are described below with reference to the drawings.

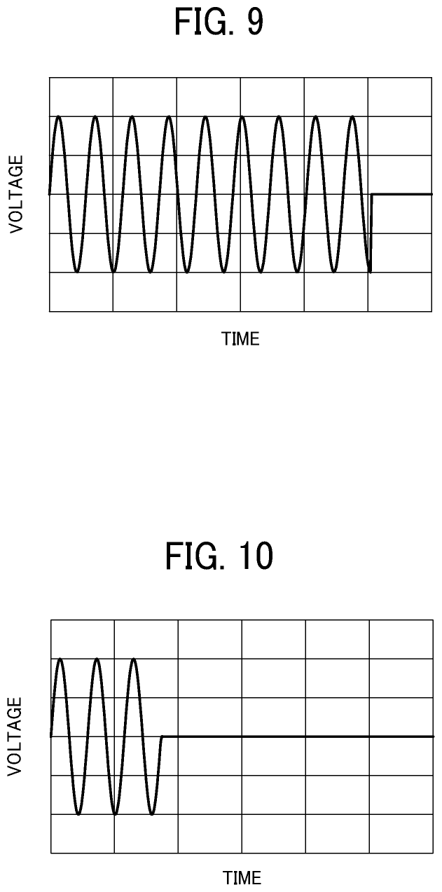

FIG. 9 is a graph of a drive signal in which the waveform of one unit pulse is a sine wave.

FIG. 9 illustrates a drive signal generated with a short period in a predetermined period, according to the present embodiment. Specifically, the same simple sine wave is continuously applied to the liquid discharge head about ten times (8.75 times to be exact). In the present disclosure, the term “continuously applied” means, for example, pulses are continuously output within a predetermined time without a waiting time at a reference voltage level. Alternatively, the pulses may have a period at 0 V to some extent.

One liquid droplet is formed (output) per unit pulse, and the interval between the unit pulses (the period of the unit pulse) is determined by the resonance frequency of the pressure chamber. Accordingly, since the displacement amount of the diaphragm gradually increases, the velocity of the liquid droplet output from the nozzle (i.e., the velocity of the liquid discharged from the pressure chamber) increases for each repetition, and the latter liquid droplet output next to the former liquid droplet catches up with the former liquid droplet output previously and coalesces into a single liquid droplet.

Thus, the droplet weight is changed.

FIG. 10 is a graph of a drive signal including a unit pulse of a simple sine wave to be repeatedly applied three times, according to the present embodiment. As described above, the volume of liquid droplets can be changed as desired according to the change in the number of simple pulses to be applied. Accordingly, the range of the variable amount of liquid droplets can be increased.

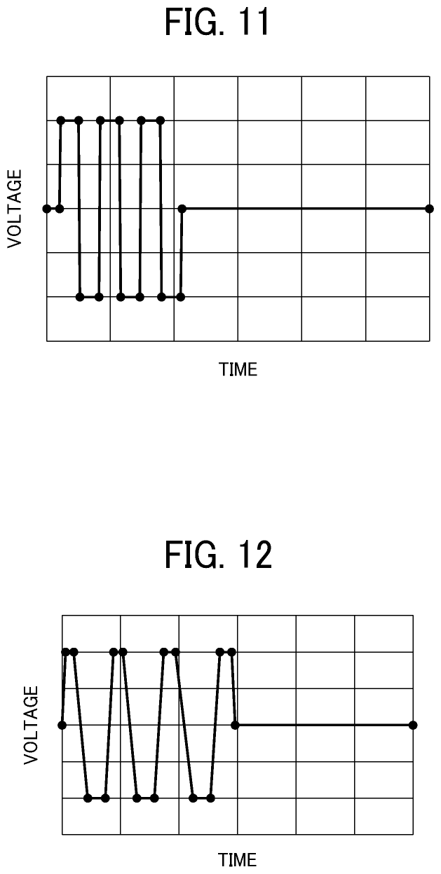

In FIGS. 9 and 10, the waveform of the unit pulse is, but is not limited to, the sine wave, and the drive signal may include any desired unit pulse to be repeatedly applied (e.g., FIGS. 11 to 13) to drive the nozzle.

FIG. 11 is a graph of a drive signal including a unit waveform of a square wave to be repeatedly applied three times, according to the present embodiment. When the unit waveform is the square wave, the waveform can be formed only by turning on and off a certain fixed voltage. Accordingly, the waveform can be formed with a relatively inexpensive power source and a simple circuit configuration.

FIG. 12 is a graph of a drive signal including a unit waveform of a trapezoidal wave to be repeatedly applied about four times (3.5 times to be exact), according to the present embodiment. When the unit waveform is the trapezoidal wave, the rise time and fall time of the voltage to be applied can be controlled. Accordingly, the velocity of each liquid droplet can be changed. As a result, the controllability of the volume of the liquid droplets finally coalescing into one is increased. Further, the ON/OFF time (i.e., a pulse width) of each unit pulse can be changed to control the volume of liquid droplets.

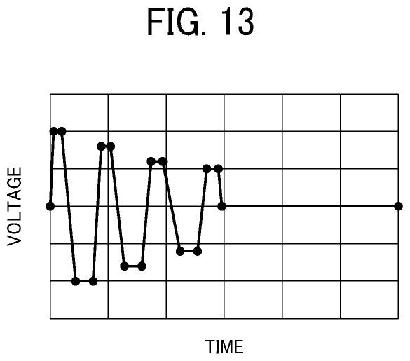

FIG. 13 is a graph of a drive signal including a drive waveform having unit waveforms in each of which the voltage is variable (e.g., the unit waveforms have different voltages, respectively), according to the present embodiment.

For example, the multiple unit pulses of the drive signal may include one or more unit pulses having different amplitudes (voltages, amounts of change in voltages).

When the liquid discharge head of the nozzle vibration type outputs liquid droplets using the resonance multi-waveform, the velocity of the liquid droplets is likely to increase with an increase in the number of pulses as described above. Even when the velocity of the liquid droplets increases, the liquid droplets can be output without any problem, but the meniscus may largely vibrate and become unstable by high-frequency driving. For this reason, the applied voltage can be sequentially lowered as long as the latter liquid droplet and the former liquid droplet coalesce into one to stabilize the meniscus in the present embodiment.

Although FIG. 13 illustrates, for example, a trapezoidal wave, the same effect can be obtained with other waveforms.

The level of the applied voltage may be set as desired for each unit pulse.

In each of the multiple unit pulses of the drive signal, the pulse width on the positive side, the pulse width on the negative side, the slope of the rising edge, and the slope of the falling edge are variable and may be changed according to the liquid droplet to be output (liquid droplet to be formed).

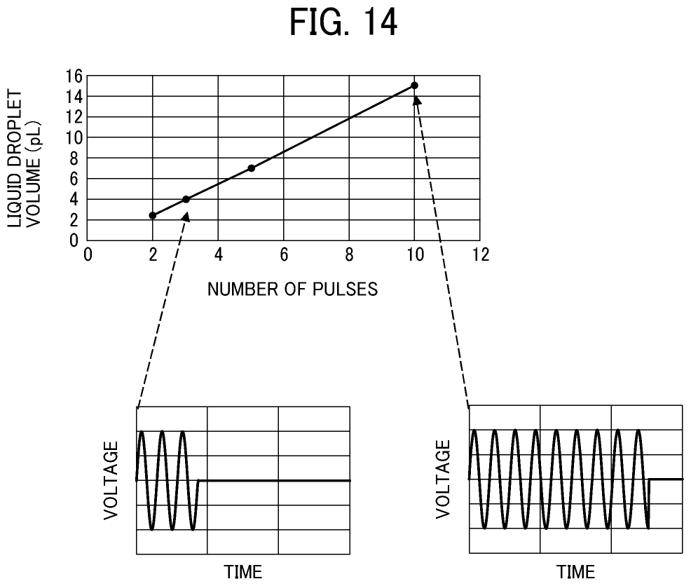

FIG. 14 is a set of graphs illustrating the relation between the number of pulses and the volume of liquid droplets when one unit pulse is continuously applied, according to the present embodiment. In the upper graph of FIG. 14, the horizontal axis represents the number of pulses, and the vertical axis represents the volume of liquid droplets (picoliter (pL)). The drive signal including three pulses is illustrated in the lower left of FIG. 14, and the drive signal including about ten pulses is illustrated in the lower right of FIG. 14, which are associated with plots in the upper graph by dashed arrows.

FIG. 14 illustrates the volume of the liquid droplets output from the nozzle driven by the unit pulses having the same waveform and the same applied voltage. The volume of the liquid droplets linearly increases with an increase in the number of pulses.

Although FIG. 14 illustrates the drive signal including unit pulses having the same applied voltage, the drive signal including unit pulses each having different applied voltages as illustrated in FIG. 13 can increase the volume of the liquid droplets as desired, corresponding to the print density and resolution.

The signal generator may also generate a drive signal including the combination of different waveforms and different applied voltages to achieve a desired volume of the liquid droplets.

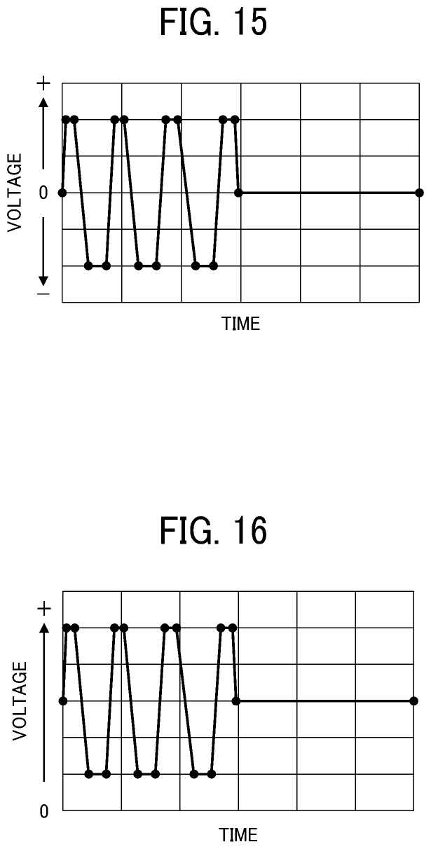

The start electric potential and the end electric potential of the drive waveform are described below with reference to FIGS. 15 to 17.

In the waveform of the unit pulse and the waveform of the unit pulses continuously applied, the start electric potential is equal to the end electric potential. The reference voltage of the waveform can be determined as desired.

FIG. 15 is a graph of a drive signal including a drive waveform in which the start electric potential is 0 V and the end electric potential is 0 V, according to the present embodiment.

For example, the signal generator may generate the drive signal having the start electric potential of 0 V and the end electric potential of 0 V. The drive signal changes to both positive and negative electric potentials.

As described above, the liquid discharge head 1 of the nozzle vibration type can use a material other than the ferroelectric material such as PZT, and can drive the nozzle using the bipolar electric fields. When the bipolar electric fields are used, the reference voltage can be set to 0 V to drive the nozzle. Accordingly, the voltage supplied from the power source can be reduced to ½. As a result, a power source that generates a relatively low voltage can be used.

FIG. 16 is a graph of a drive signal including a drive waveform in which the start electric potential is positive, the end electric potential is positive, and an electric potential at any point of the drive waveform is positive larger than 0 V.

For example, the signal generator may generate the drive signal having the positive start electric potential and the positive end electric potential. The drive signal changes within positive electric potentials.

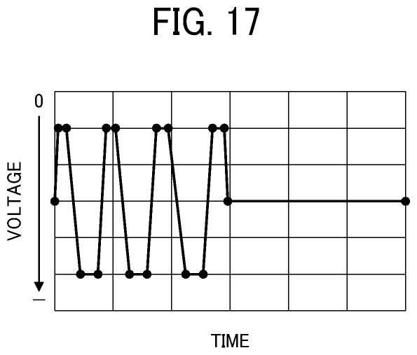

FIG. 17 is a graph of a drive signal including a drive waveform in which the start electric potential is negative, the end electric potential is negative, and an electric potential at any point of the drive waveform is negative smaller than 0 V, according to the present embodiment.

For example, the signal generator may generate the drive signal having the negative start electric potential and the negative end electric potential. The drive signal changes within negative electric potentials.

In the embodiments illustrated in FIGS. 16 and 17, the applied voltage is larger than that of the bipolar electric fields, but the voltage is not inverted. As a result, a power source having a relatively simple circuit configuration can be used.

A piezoelectric material other than the ferroelectric material allows the drive voltage to be set as desired. For example, when a ferroelectric material such as PZT is used as the piezoelectric body, the drive voltages illustrated in FIGS. 16 and 17 are used. On the other hand, when a material other than the ferroelectric material such as PZT is used as the piezoelectric body, the drive voltages illustrated in FIGS. 15 to 17 can be used, and accordingly, the range of selection of the power source is increased.

The states of the nozzle driven by the drive waveforms of FIGS. 13 and 15 to 17 are described below.

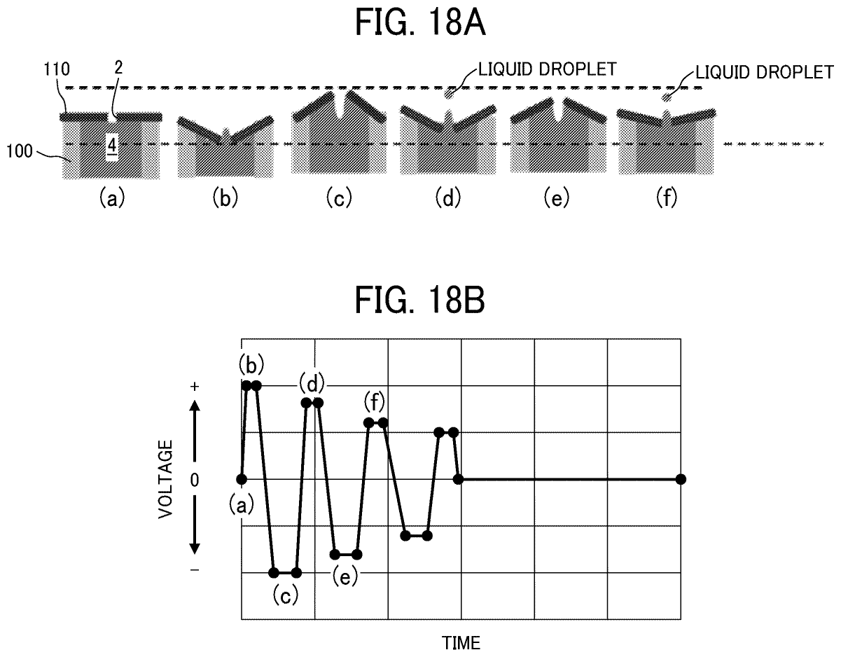

FIG. 18A is a schematic diagram illustrating the movement of the diaphragm when the drive waveform of FIG. 13 is applied to the liquid discharge head of FIG. 1. FIG. 18B is a graph illustrating the drive waveform of FIG. 13.

Since the amplitude of the drive waveform is different for each unit pulse, the change in the amplitude is reflected in the state of the nozzle 2 driven by the drive waveform (the displacement amount of the nozzle 2). Thus, the volume of the pressurization chamber 4 can be changed.

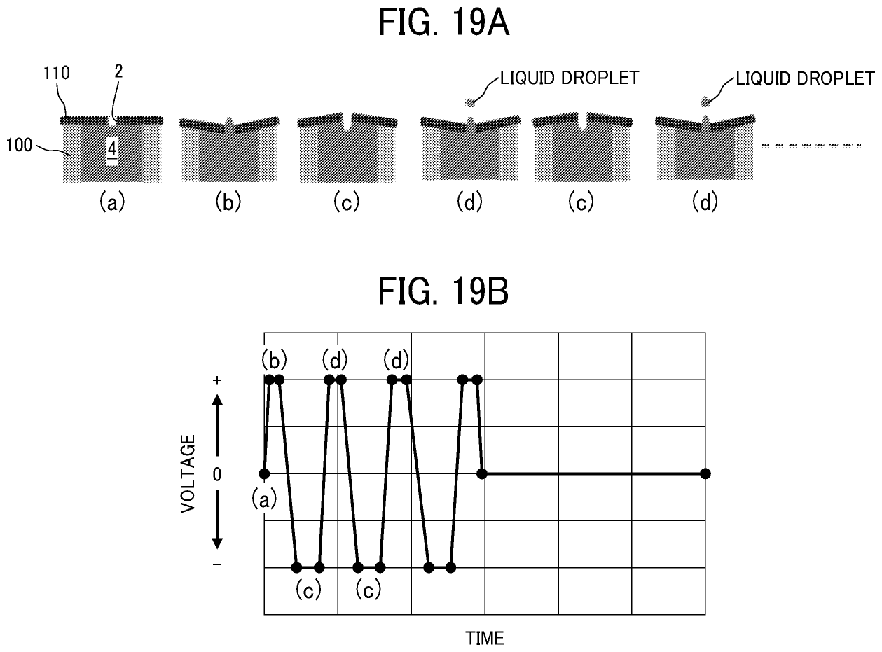

FIG. 19A is a schematic diagram illustrating the movement of the diaphragm when the drive waveform of FIG. 15 is applied to the liquid discharge head of FIG. 1. FIG. 19B is a graph illustrating the drive waveform of FIG. 15.

FIGS. 19A and 19B illustrate the relation between the state of the diaphragm and the drive waveform when the drive waveform is changed between a positive electric potential and a negative electric potential.

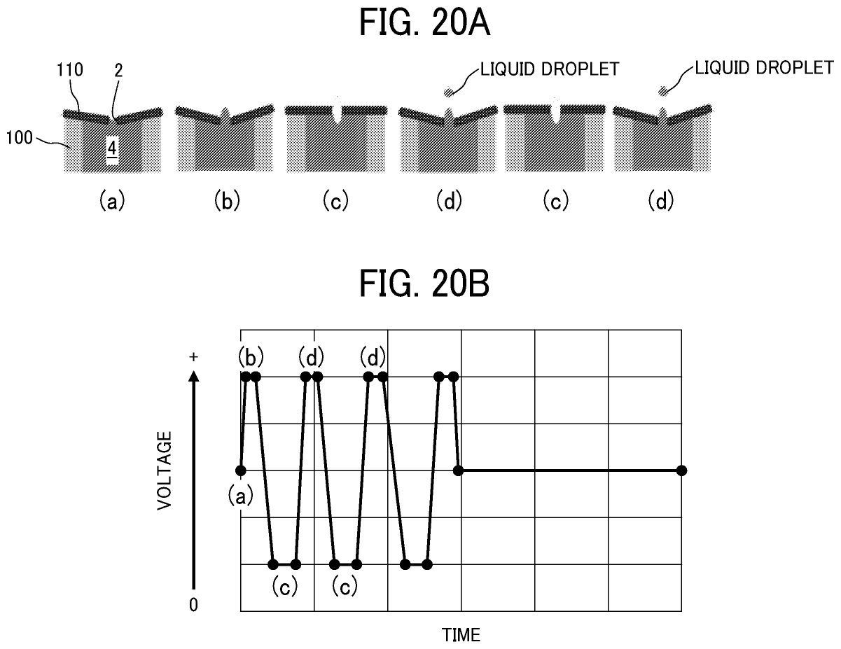

FIG. 20A is a schematic diagram illustrating the movement of the diaphragm when the drive waveform of FIG. 16 is applied to the liquid discharge head of FIG. 1. FIG. 20B is a graph illustrating the drive waveform of FIG. 16.

FIGS. 20A and 20B illustrate the relation between the state of the diaphragm and the drive waveform when the drive waveform is changed within positive electric potentials. The displacement amount of the diaphragm in a state (b) of FIG. 20A is twice the displacement amount of the diaphragm in a state (a) of FIG. 20A.

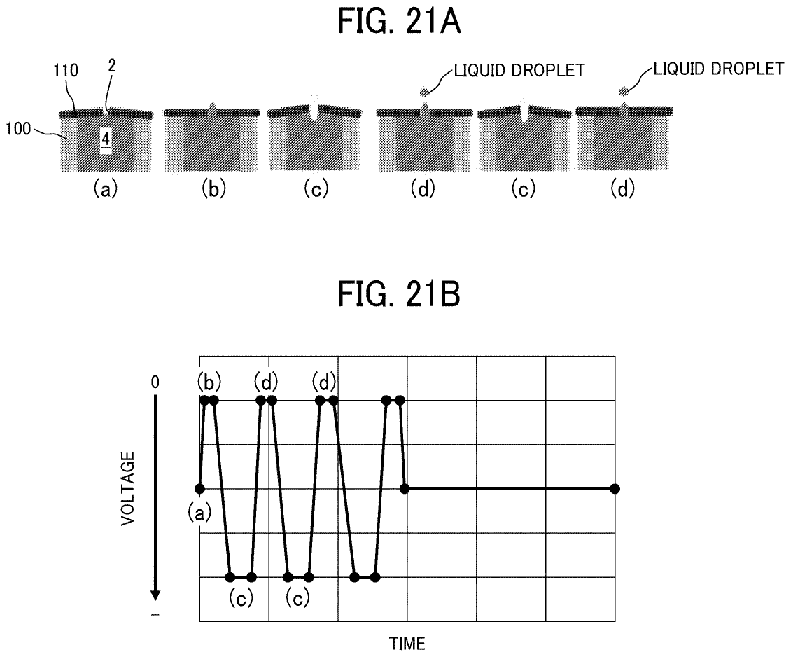

FIG. 21A is a schematic diagram illustrating the movement of the diaphragm when the drive waveform of FIG. 17 is applied to the liquid discharge head of FIG. 1. FIG. 21B is a graph illustrating the drive waveform of FIG. 17.

FIGS. 21A and 21B illustrate the relation between the state of the diaphragm and the drive waveform when the drive waveform is changed within negative electric potentials. The displacement amount of the diaphragm in a state (c) of FIG. 21A is twice the displacement amount of the diaphragm in a state (a) of FIG. 21A.

The state of the nozzle 2 driven by the drive waveforms of FIGS. 9 to 12 is, for example, the same as that of FIG. 19A. However, since the shape of the drive waveforms is different from that of FIG. 19B, the period in which the diaphragm is held in each of the states (a) and (b), and the period in which the diaphragm is displaced from the state (a) to the state (b), or from the state (b) to the state (c) are different from those of FIG. 19A.

In FIGS. 19A to 21B described above, the relation between the diaphragm and the drive signal can also be described as follows. In FIGS. 19A to 21B, one unit pulse of the drive signal is a combination of two pulses having amplitudes in opposite directions.

FIGS. 19A and 19B illustrate the change in the state of the diaphragm when the drive signal has the start electric potential of 0 V and the end electric potential of 0 V, and changes to both positive and negative electric potentials, according to the present embodiment. The diaphragm at the start electric potential of 0 V is located at a first position (i.e., the state (a) of FIG. 19A).

In the first position, the diaphragm is flat, and the nozzle 2 and the diaphragm (vibration film 103) are disposed on one plane (in a straight line). The first position may be referred to as a “neutral position.”

When the diaphragm is located at a second position (i.e., the state (c) of FIG. 19A), the volume of the pressurization chamber 4 is larger than the volume at the first position. When the diaphragm is located at a third position (i.e., the state (d) of FIG. 19A), the volume of the pressurization chamber 4 is smaller than the volume at the first position.

In the drive waveform of FIG. 19B, the diaphragm is at the second position when the drive signal is a negative electric potential (i.e., a time range (c) of FIG. 19B), and the diaphragm is at the third position when the drive signal is a positive electric potential (i.e., a time range (d) of FIG. 19B).

When the voltage of the drive signal rises from the negative electric potential to the positive electric potential (i.e., the rising edge of the drive signal from the time range (c) to the time range (d) of FIG. 19B), the diaphragm is displaced from the second position to the third position (from the state (c) to the state (d) of FIG. 19A) to cause the liquid discharge head 1 to discharge liquid from the nozzle 2 to form a liquid droplet.

FIGS. 20A and 20B illustrate the change in the state of the diaphragm when the drive signal has a positive start electric potential and a positive end electric potential, and changes within positive electric potentials, according to the present embodiment.

In FIG. 20A, the diaphragm is at the first position when the drive signal is a low electric potential lower than the start electric potential (i.e., a time range (c) of FIG. 20A), and the diaphragm is at the third position when the drive signal is a high electric potential higher than the start electric potential (i.e., a time range (d) of FIG. 20A). The diaphragm is not located at the second position.

In the drive waveform of FIG. 20B, when the voltage of the drive signal falls from the high electric potential to the low electric potential (i.e., the falling edge of the drive signal from a time range (b) to the time range (c) of FIG. 20B), the diaphragm is at the first position (the state (c) of FIG. 20A). When the voltage of the drive signal rises from the low electric potential, at which the diaphragm is located at the first position, to the high electric potential (i.e., the rising edge of the drive signal from the time range (c) to the time range (d) of FIG. 20B), the diaphragm is displaced from the first position to the third position (from the state (c) to the state (d) of FIG. 20A) to cause the liquid discharge head 1 to discharge liquid from the nozzle 2 to form a liquid droplet.

FIGS. 21A and 21B illustrate the change in the state of the diaphragm when the drive signal has a negative start electric potential and a negative end electric potential, and changes within negative electric potentials.

In FIG. 21A, the diaphragm is at the first position when the drive signal is a high electric potential higher than the start electric potential (i.e., time ranges (b) and (d) of FIG. 21B), and the diaphragm is at the second position when the drive signal is a low electric potential lower than the start electric potential (i.e., a time range (c) of FIG. 21B). The diaphragm is not located at the third position.

In the drive waveform of FIG. 21B, when the voltage of the drive signal rises to the high electric potential (i.e., the rising edge of the drive signal from the time range (a) to the time range (b) or from the time range (c) to the time range (d) of FIG. 21B), the diaphragm is at the first position (the state (b) or (d) of FIG. 21A). When the voltage of the drive signal falls from the high electric potential, at which the diaphragm is located at the first position, to the low electric potential (i.e., the falling edge of the drive signal from the time range (b) to the time range (c) or from the time range (d) to the time range (c) of FIG. 21B), the diaphragm is displaced from the first position to the second position (from the state (b) to the state (c) or from the state (d) to the state (c) of FIG. 21A). Then, when the voltage of the drive signal rises from the low electric potential to the high electric potential (i.e., the rising edge of the drive signal from the time range (c) to the time range (d) of FIG. 21B), the diaphragm is displaced from the second position to the first position (from the state (c) to the state (d) of FIG. 21A) to cause the liquid discharge head 1 to discharge liquid from the nozzle 2 to form a liquid droplet.

A modification of one unit pulse is described below.

In the above embodiments, one unit pulse is, but is not limited to, a combination of two pulses having amplitudes in opposite directions. One unit pulse is a pulse that can cause liquid to be discharged from the nozzle to form one liquid droplet. For example, the one unit pulse may be a pulse having an amplitude in one direction.

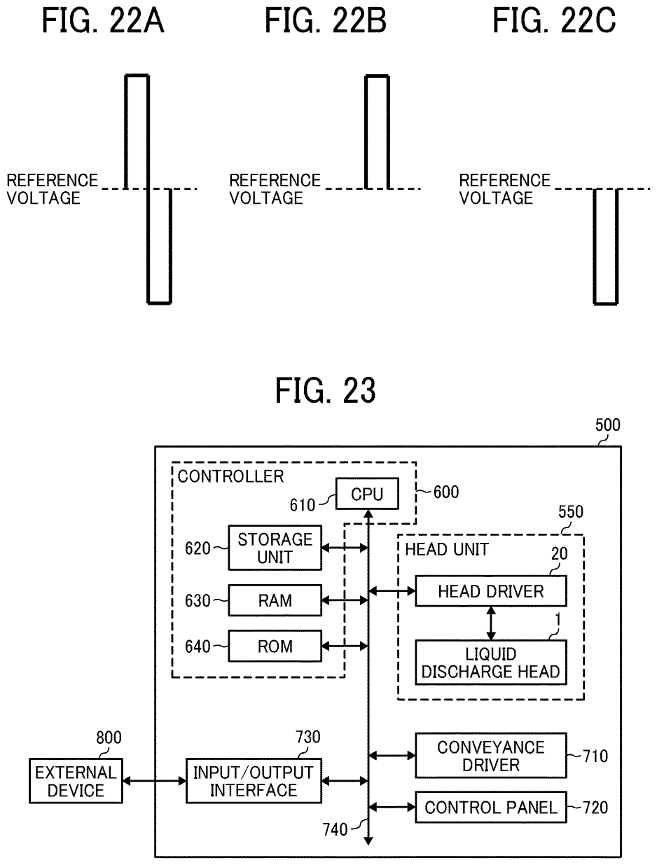

FIGS. 22A to 22C are diagrams each illustrating the shape of one unit pulse, according to the present embodiment.

In FIG. 22A, one unit pulse is a combination of two pulses having amplitudes in opposite directions. In FIG. 22B, the voltage of the drive signal rises and then falls in one unit pulse. In FIG. 22C, the voltage of the drive signal falls and then rises in one unit pulse. For example, the start electric potential and the end electric potential are lowest in the drive signal illustrated in FIG. 22B. The start electric potential and the end electric potential are highest in the drive signal illustrated in FIG. 22C.

Although the drive waveform illustrated in FIG. 11 is used in the description with reference to FIGS. 22A to 22C, other drive waveforms such as the drive waveforms in FIGS. 9, 10, 12, and 13 can be modified to a drive waveform including one unit pulse having an amplitude in one direction.

A controller mounted on a printing apparatus 500 as a liquid discharge apparatus according to an embodiment of the present disclosure is described below. In the present embodiment, the printing apparatus 500 is an inkjet recording apparatus.

FIG. 23 is a block diagram illustrating a hardware configuration of a control system of the printing apparatus 500 (inkjet recording apparatus) including a head unit, according to the present embodiment.

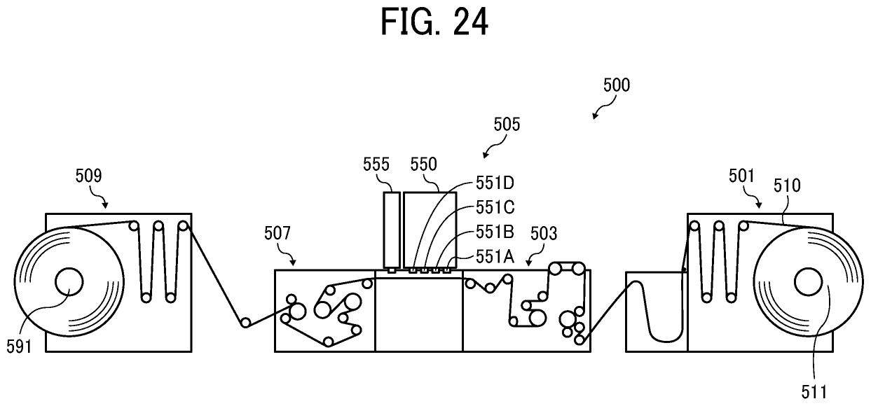

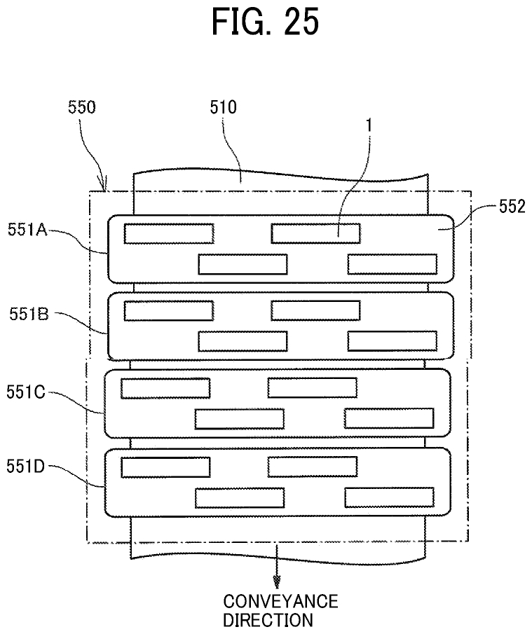

The printing apparatus 500 according to the present embodiment includes a head unit 550, a controller 600, a conveyance driver 710, a control panel 720, and an input/output interface 730, which are connected to each other via a bus line 740. The printing apparatus 500 and the head unit 550 are described later with reference to FIGS. 24 and 25.

The head driver 20 generates a drive waveform in response to a control signal input from the controller 600 to deform each piezoelectric element. The piezoelectric element is an electromechanical transducer element serving as an actuator in each nozzle row. In the liquid discharge head 1, when the drive waveform is input to each piezoelectric element of the nozzle rows, the liquid in the pressure chamber communicating with the nozzle 2 is pressurized (i.e., an energy for discharging liquid is applied) to discharge liquid such as ink from the corresponding nozzle 2.

The head driver 20 serves as the signal generator (e.g., the drive circuit 101 of FIG. 3) described above.

The controller 600 includes a central processing unit (CPU) 610, a storage unit 620, a random-access memory (RAM) 630, and a read-only memory (ROM) 640. The CPU 610 loads various control programs and settings stored in the ROM 640 into the RAM 630 to execute the programs to perform various arithmetic processing. The CPU 610 controls the overall operation of the printing apparatus 500.

The storage unit 620 stores, for example, a print job (image recording command) input via the input/output interface 730.

The conveyance driver 710 transmits a driving signal to a conveyance motor based on a control signal supplied from the controller 600 to convey a recording medium at a predetermined speed and timing.

The control panel 720 includes a display device such as a liquid-crystal display or an organic electroluminescent display, and an input device such as a touch panel overlaid on the screen of the display device. The control panel 720 displays various kinds of information on the display device, and transmits an operation signal corresponding to a user's input operation on the input device to the controller 600.

The input/output interface 730 mediates the transmission and reception of data between an external device 800 and the controller 600.

The bus line 740 is a path through which signals are transmitted and received between the controller 600 and other components.

The arrangement of the signal generator is described below.

The liquid discharge apparatus according to the above-described embodiment includes the signal generator, and the signal generator can be disposed inside or outside the liquid discharge head.

For example, in FIG. 3, the drive circuit 101 serving as the signal generator is disposed in the liquid discharge head 1, but the arrangement of the signal generator is not limited thereto. For example, the signal generator may be disposed outside the liquid discharge head 1, and may control the amount of liquid droplets to be output via the wiring 102. For example, the signal generator may be disposed outside the liquid discharge head in a liquid discharge unit or a liquid discharge apparatus including the liquid discharge head of the nozzle vibration type.

For example, the signal generator implements a function of controlling the amount of liquid droplets by the variable-size droplet method with multi-drop, based on the control from a liquid discharge apparatus or a liquid discharge unit including a liquid discharge head.

The liquid discharge apparatus or the liquid discharge unit may include multiple liquid discharge mechanisms (e.g., the liquid discharge heads 1). As the arrangement of the signal generator in the liquid discharge head, the liquid discharge mechanism includes a substrate (e.g., the channel substrate 100), a pressure chamber (e.g., the pressurization chamber 4) formed in the substrate, a nozzle (e.g., the nozzle 2) from which a liquid in the pressure chamber is discharged, an actuator (e.g., the piezoelectric element 5) including a piezoelectric body (e.g., the piezoelectric film 52) to discharge the liquid from the nozzle to form a liquid droplet, a diaphragm (e.g., the vibration film 103) holding the actuator, a partition (e.g., an insulating layer including the wiring 102) separating the diaphragm and the pressure chamber adjacent to the diaphragm, and a signal generator (e.g., the drive circuit 101).

The liquid discharge apparatus or the liquid discharge unit may include multiple liquid discharge mechanisms and a signal generator. As the arrangement of the signal generator disposed outside the liquid discharge head, the liquid discharge mechanism includes a substrate (e.g., the channel substrate 100) including a pressure chamber (e.g., the pressurization chamber 4), a nozzle (e.g., the nozzle 2) from which a liquid in the pressure chamber is discharged, an actuator (e.g., the piezoelectric element 5) including a piezoelectric body (e.g., the piezoelectric film 52) to discharge the liquid from the nozzle to form a liquid droplet, a diaphragm (e.g., the vibration film 103) holding the actuator, and a partition (e.g., an insulating layer including the wiring 102) separating the diaphragm and the pressure chamber adjacent to the diaphragm.

The name and the reference numeral in parentheses correspond to the configuration illustrated in FIGS. 1 to 3. The multiple liquid discharge mechanisms are the liquid discharge heads of the nozzle vibration type.

In a printing apparatus (image forming apparatus) as the liquid discharge apparatus including the liquid discharge head of the nozzle vibration type, for example, the signal generator may implement the function of controlling the amount of liquid droplets by the variable-size droplet method with multi-drop in a control unit of the printing apparatus.

As illustrated in FIG. 3, the liquid discharge head 1 according to the present embodiment includes a substrate (i.e., the channel substrate 100) including a pressure chamber (e.g., the pressurization chamber 4), a nozzle (e.g., the nozzle 2) from which a liquid in the pressure chamber is discharged, an actuator (e.g., the piezoelectric element 5) including a piezoelectric body (e.g., the piezoelectric film 52) to discharge the liquid from the nozzle to form a liquid droplet, a diaphragm (e.g., the vibration film 103) holding the actuator, a partition (e.g., an insulating layer including the wiring 102) separating the diaphragm and the pressure chamber adjacent to the diaphragm, and a signal generator (e.g., the drive circuit 101).

The printing apparatus 500 which is the inkjet recording apparatus as a liquid discharge head according to an embodiment of the present disclosure is described below with reference to FIGS. 24 and 25. FIG. 24 is a schematic view of the printing apparatus 500, according to the present embodiment. FIG. 25 is a plan view of the head unit 550 of the printing apparatus 500 of FIG. 24.

The printing apparatus 500 serving as the liquid discharge apparatus according to the present embodiment includes a feeder 501, a guide conveyor 503, a printer 505, a dryer 507, and a carrier 509. The feeder 501 feeds a continuous medium 510 inward. The guide conveyor 503 guides and conveys the continuous medium 510 such as a continuous sheet of paper or a sheet medium fed inward from the feeder 501. The printer 505 performs printing by discharging liquid onto the continuous medium 510 to form an image. The dryer 507 dries the continuous medium 510 with the image formed. The carrier 509 feeds the dried continuous medium 510 outward.

The continuous medium 510 is fed from a winding roller 511 of the feeder 501, guided and conveyed with rollers of the feeder 501, the guide conveyor 503, the dryer 507, and the carrier 509, and wound around a take-up roller 591 of the carrier 509.

In the printer 505, the continuous medium 510 is conveyed on a conveyance guide so as to face the head unit 550 and a head unit 555. An image is formed with liquid discharged from the head unit 550, and post-treatment is performed with treatment liquid discharged from the head unit 555.

The head unit 550 includes, for example, full-line head arrays 551A, 551B, 551C, and 551D for four colors from the upstream side in a conveyance direction of the continuous medium 510. The full-line head arrays 551A, 551B, 551C, and 551D may be referred to simply as the “head array 551” when colors are not distinguished.

Each of the head arrays 551 is a liquid discharger to discharge liquid of black (K), cyan (C), magenta (M), or yellow (Y) onto the continuous medium 510 conveyed in the conveyance direction. The number and types of colors are not limited to the above-described four colors of K, C, M, and Y and may be any other suitable number and types.

In each head array 551, for example, as illustrated in FIG. 25, the liquid discharge heads 1 according to the present embodiment are disposed in a staggered arrangement on a base 552 to form the head array 551. The configuration of the head array 551 is not limited thereto. The liquid discharge head 1 may be referred to simply as the “head 1.”

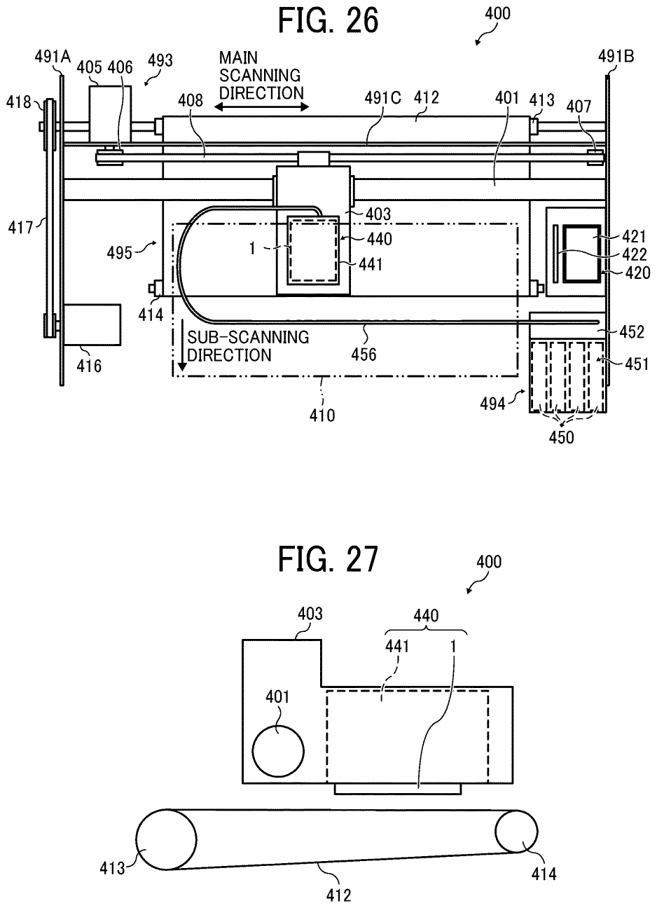

Another printing apparatus as a liquid discharge apparatus according to an embodiment of the present disclosure is described below with reference to FIGS. 26 and 27. FIG. 26 is a plan view of a part of the printing apparatus, according to the present embodiment. FIG. 27 is a side view of the part of the printing apparatus of FIG. 26.

A printing apparatus 400 is a serial-type apparatus in which a main-scanning moving mechanism 493 reciprocates a carriage 403 in the main scanning direction. The main-scanning moving mechanism 493 includes, for example, a guide 401, a main-scanning motor 405, and a timing belt 408. The guide 401 is bridged between left and right side plates 491A and 491B to movably hold the carriage 403. The main-scanning motor 405 reciprocates the carriage 403 in the main scanning direction via the timing belt 408 looped around a drive pulley 406 and a driven pulley 407.

The carriage 403 mounts a liquid discharge unit 440 including the liquid discharge head 1 according to the above-described embodiments of the present disclosure and a head tank 441 as a single integrated unit. The liquid discharge head 1 of the liquid discharge unit 440 discharges color liquids of, for example, yellow (Y), cyan (C), magenta (M), and black (K).

The liquid discharge head 1 is mounted on the liquid discharge unit 440 of the carriage 403 such that a nozzle row including multiple nozzles is arranged in the sub-scanning direction perpendicular to the main scanning direction. The liquid discharge head 1 discharges the color liquid downward.

A supply mechanism 494 disposed outside the liquid discharge head 1 supplies liquid stored in liquid cartridges 450 to the head tank 441 to supply the liquid to the liquid discharge head 1.

The supply mechanism 494 includes a cartridge holder 451 which is a filling part to mount the liquid cartridges 450, a tube 456, and a liquid feed unit 452 including a liquid feed pump.

The liquid cartridge 450 is detachably mounted on the cartridge holder 451. The liquid feed unit 452 feeds the liquid from the liquid cartridge 450 to the head tank 441 via the tube 456.

The printing apparatus 400 further includes a conveyance mechanism 495 to convey a sheet 410. The conveyance mechanism 495 includes a conveyance belt 412 as a conveyor and a sub-scanning motor 416 to drive the conveyance belt 412.

The conveyance belt 412 attracts the sheet 410 and conveys the sheet 410 to a position facing the liquid discharge head 1. The conveyance belt 412 is an endless belt looped around a conveyance roller 413 and a tension roller 414. The sheet 410 can be attracted to the conveyance belt 412 by, for example, electrostatic attraction or air suction.

The conveyance belt 412 circumferentially moves in a sub-scanning direction as the conveyance roller 413 is rotationally driven by the sub-scanning motor 416 via a timing belt 417 and a timing pulley 418.

On one end of the range of movement of the carriage 403 in the main scanning direction, a maintenance mechanism 420 that maintains and recovers the liquid discharge head 1 is disposed lateral to the conveyance belt 412.

The maintenance mechanism 420 includes, for example, a cap 421 to cap the nozzle face (i.e., the surface on which the nozzles 4 are formed) of the liquid discharge head 1 and a wiper 422 to wipe the nozzle face.

The main-scanning moving mechanism 493, the supply mechanism 494, the maintenance mechanism 420, and the conveyance mechanism 495 are mounted onto a housing including the side plates 491A and 491B and a back plate 491C.

In the printing apparatus 400 having the above-described configuration, the sheet 410 is fed and attracted onto the conveyance belt 412 and conveyed in the sub-scanning direction as the conveyance belt 412 circumferentially moves.

The liquid discharge head 1 is driven in response to an image signal while the carriage 403 moves in the main scanning direction to discharge liquid onto the sheet 410 not in motion. As a result, an image is formed on the sheet 410.

As described above, the printing apparatus 400 includes the liquid discharge head 1 according to the above-described embodiments of the present disclosure, thus allowing the stable formation of high-quality images.

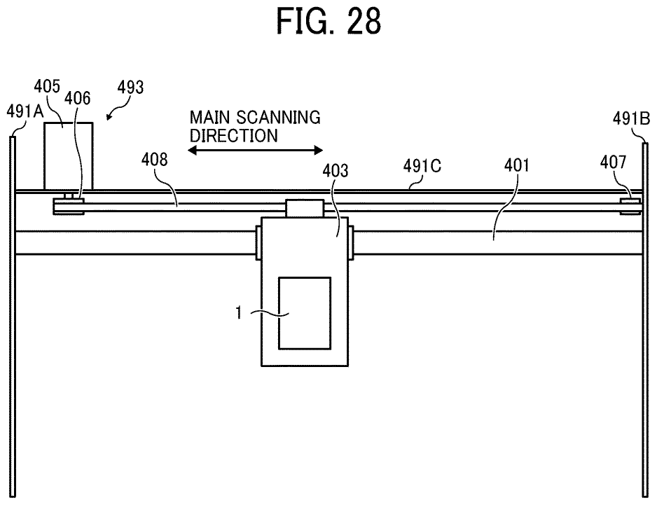

A liquid discharge unit according to an embodiment of the present disclosure is described below with reference to FIG. 28. FIG. 28 is a plan view of a part of the liquid discharge unit, according to the present embodiment.

The liquid discharge unit includes the housing, the main-scanning moving mechanism 493, the carriage 403, and the liquid discharge head 1 among the components of the printing apparatus 400 described above. The side plates 491A and 491B, and the back plate 491C construct the housing.

The liquid discharge unit 440 may further include at least one of the maintenance mechanism 420 and the supply mechanism 494, which may be attached to the side plate 491B.

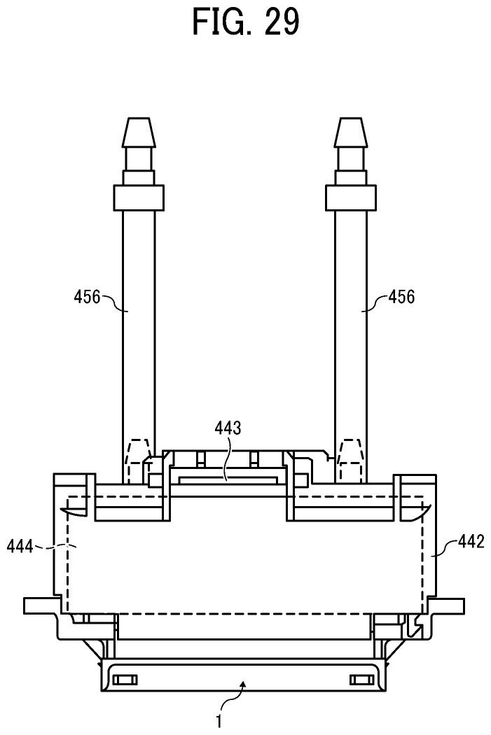

Another liquid discharge unit according to an embodiment of the present disclosure is described below with reference to FIG. 29. FIG. 29 is a front view of the liquid discharge unit, according to the present embodiment.

The liquid discharge unit according to the present embodiment includes the liquid discharge head 1 to which a channel component 444 is attached and tubes 456 connected to the channel component 444.

The channel component 444 is disposed inside a cover 442. Alternatively, the liquid discharge unit 440 may include the head tank 441 instead of the channel component 444. A connector 443 for electrically connecting to the liquid discharge head 1 is provided on an upper portion of the channel component 444.

In the above-described embodiments, the “liquid discharge apparatus” includes the liquid discharge head or the liquid discharge unit and drives the liquid discharge head to discharge liquid. The liquid discharge apparatus may be, for example, any apparatus that can discharge liquid to a medium onto which liquid can adhere or any apparatus to discharge liquid toward gas or into liquid.

The “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials of the “medium onto which liquid can adhere” include any materials to which liquid can adhere even temporarily, such as paper, thread, fiber, fabric, leather, metal, plastic, glass, wood, ceramic, construction materials (e.g., wallpaper or floor material), and cloth textile.

Examples of the “liquid” include ink, treatment liquid, deoxyribonucleic acid (DNA) sample, resist, pattern material, binder, fabrication liquid, and solution or liquid dispersion containing amino acid, protein, or calcium. Further, the “liquid” may be a molten metal such as solder.

The liquid discharge apparatus may be an apparatus to move the liquid discharge head and the material onto which liquid can adhere relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

The “liquid discharge unit” refers to a liquid discharge head integrated with functional components or mechanisms, i.e., an assembly of components related to liquid discharge. For example, the “liquid discharge unit” includes a combination of the liquid discharge head with at least one of a head tank, a carriage, a supply mechanism, a maintenance mechanism, or a main-scanning moving mechanism.

The integrated unit may be, for example, a combination in which the liquid discharge head and a functional part(s) are secured to each other through, e.g., fastening, bonding, or engaging, and a combination in which one of the liquid discharge head and a functional part(s) is movably held by another. The liquid discharge head may be detachably attached to the functional part(s) or unit(s) each other.

Examples of the liquid discharge unit include the liquid discharge unit 440 in which a liquid discharge head and a head tank are integrated, as illustrated in FIG. 27. Alternatively, the liquid discharge head and the head tank coupled (connected) to each other via, for example, a tube may form the liquid discharge unit as a single unit. A unit including a filter may further be added to a portion between the head tank and the liquid discharge head of the liquid discharge unit.

In another example, the liquid discharge unit may be an integrated unit in which a liquid discharge head is integrated with a carriage.

As yet another example, the liquid discharge unit is a unit in which the liquid discharge head and the main-scanning moving mechanism are combined into a single unit. The liquid discharge head is movably held by a guide that is a part of the main-scanning moving mechanism. Like the liquid discharge unit 440 illustrated in FIG. 28, the liquid discharge head, the carriage, and the main-scanning moving mechanism may form the liquid discharge unit as a single unit.

In another example, the cap that forms a part of the maintenance mechanism is secured to the carriage mounting the liquid discharge head so that the liquid discharge head, the carriage, and the maintenance mechanism are integrated as a single unit to form the liquid discharge unit.

Further, in still another example, the liquid discharge unit includes tubes connected to the liquid discharge head to which the head tank or the channel component is attached so that the liquid discharge head and the supply mechanism are integrated as a single unit, as illustrated in FIG. 29.

The main-scanning moving mechanism may be a guide only. The supply mechanism may be a tube(s) only or a loading device only.

The liquid discharge head is not limited in the type of pressure generator used. The pressure generator is not limited to the piezoelectric actuator (or a laminated-type piezoelectric element) described in the above-described embodiments, and may be, for example, a thermal actuator that employs a thermoelectric transducer element, such as a thermal resistor, or an electrostatic actuator including a diaphragm and opposed electrodes.

In the present specification, the terms “image formation,” “recording,” “printing,” “image printing,” and “fabricating” used herein may be used synonymously with each other.

Note that numerous additional modifications and variations are possible in light of the above teachings. It is therefore to be understood that within the scope of the appended claims, the embodiments of the present disclosure may be practiced otherwise than as specifically described herein. For example, elements and/or features of different illustrative embodiments may be combined with each other and/or substituted for each other within the scope of this disclosure and appended claims.

### Aspects of the Present Disclosure Are, for Example, As Follows.

### Aspect 1

A liquid discharge apparatus includes a substrate having a pressure chamber, a nozzle to discharge a liquid in the pressure chamber, an actuator including a piezoelectric body to discharge the liquid from the nozzle to form a liquid droplet, a diaphragm holding the actuator, and a signal generator. The liquid discharge apparatus changes a position of the diaphragm to drive the nozzle to discharge the liquid. A unit pulse is a pulse having the same start electric potential and end electric potential to form one liquid droplet. The signal generator generates multiple unit pulses as a drive signal within a predetermined period. The signal generator changes the amount of liquid droplets to be output according to the number of unit pulses.

In other words, a liquid discharge apparatus includes a substrate having a pressure chamber, an actuator forming layer, and a signal generator. The actuator forming layer includes a nozzle forming portion having a nozzle from which a liquid in the pressure chamber is dischargeable, an actuator including an annular piezoelectric body disposed around the nozzle, a diaphragm holding the actuator. The signal generator generates a drive signal including multiple unit pulses in a predetermined period, applies the multiple unit pulses of the drive signal to the actuator to vibrate the actuator forming layer to discharge multiple liquid droplets from the nozzle and merge the multiple liquid droplets to form one liquid droplet, and varies a number of the multiple unit pulses continuously applied to the actuator to vary an amount of the one liquid droplet discharged from the nozzle. Each of the multiple unit pulses has a start electric potential and an end electric potential equal to the start electric potential.

### Aspect 2

In the liquid discharge apparatus according to Aspect 1, the drive signal changes between a positive electric potential and a negative electric potential.

In other words, the signal generator generates the drive signal that changes between a positive electric potential and a negative electric potential.

### Aspect 3

In the liquid discharge apparatus according to Aspect 1, the start electric potential and the end electric potential of the drive signal are positive, and the drive signal changes within positive electric potentials.

In other words, the signal generator generates the drive signal that changes within a positive electric potential, and the drive signal has the start electric potential and the end electric potential each of which is the positive electric potential.

### Aspect 4

In the liquid discharge apparatus according to Aspect 1, the start electric potential and the end electric potential of the drive signal are negative, and the drive signal changes within negative electric potentials.

In other words, the signal generator generates the drive signal that changes within a negative electric potential, and the drive signal has the start electric potential and the end electric potential each of which is the negative electric potential.

### Aspect 5

In the liquid discharge apparatus according to any one of Aspects 1 to 4, the multiple unit pulses include one or more unit pulses having different amplitudes.

### Aspect 6

In the liquid discharge apparatus according to any one of Aspects 1 to 5, the diaphragm changes so as to decrease the volume of the pressure chamber when a drive voltage rises, and changes so as to increase the volume of the pressure chamber when the drive voltage falls, and discharges the liquid when the drive voltage rises.

In other words, the signal generator generates the drive signal having a rising edge to displace the diaphragm toward the pressure chamber to decrease a volume of the pressure chamber to discharge the liquid from the nozzle and a falling edge to displace the diaphragm away from the pressure chamber to increase the volume of the pressure chamber.

### Aspect 7

In the liquid discharge apparatus according to Aspect 6, the unit pulse is a combination of two pulses having amplitudes in different directions. When the start electric potential and the end electric potential are 0 V and the drive signal changes between a positive electric potential and a negative electric potential, the position of the diaphragm at the start electric potential of 0 V is a first position, and the liquid is discharged when the drive signal rises from the negative electric potential to the positive electric potential. When the start electric potential and the end electric potential are positive and the drive signal changes within positive electric potentials, the position of the diaphragm is the first position when the drive signal falls, and the liquid is discharged when the drive signal rises from the first position. When the start electric potential and the end electric potential are negative and the drive signal changes within negative electric potentials, the position of the diaphragm is the first position when the drive signal rises, and the liquid is discharged when the drive signal rises after falling from the first position.

In other words, each of the multiple unit pulses is a combination of two pulses having amplitudes in opposite directions. The signal generator generates the drive signal that changes between a positive electric potential and a negative electric potential. The drive signal has the start electric potential and the end electric potential each of which is equal to 0 V, at which the diaphragm is at a neutral position, and the rising edge rising from the negative electric potential to the positive electric potential to discharge the liquid from the nozzle.

Alternatively, each of the multiple unit pulses is a combination of two pulses having amplitudes in opposite directions. The signal generator generates the drive signal that changes within a positive electric potential. The drive signal has the start electric potential and the end electric potential each of which is the positive electric potential, the falling edge to displace the diaphragm to a neutral position, and the rising edge to displace the diaphragm from the neutral position toward the pressure chamber to discharge the liquid from the nozzle. Still alternatively, each of the multiple unit pulses is a combination of two pulses having amplitudes in opposite directions. The signal generator generates the drive signal that changes within a negative electric potential. The drive signal has the start electric potential and the end electric potential each of which is the negative electric potential, the rising edge to displace the diaphragm to a neutral position, and the falling edge and another rising edge after the falling edge to displace the diaphragm to the neutral position to discharge the liquid from the nozzle.

### Aspect 8

In the liquid discharge apparatus according to any one of Aspects 1 to 7, the number of the unit pulses is five or more continuous multiple pulses.

In other words, the number of the multiple unit pulses is five or more, and the multiple unit pulses are continuous.

### Aspect 9

In the liquid discharge apparatus according to any one of Aspects 1 to 8, the amount of liquid droplets which changes in response to the number of unit pulses is five times or more than the unit pulse.

In other words, the amount of the one liquid droplet changes five or more times an amount of one of the multiple liquid droplets discharged by one of the multiple unit pulses in response to the number of the multiple unit pulses.

### Aspect 10

In a method for discharging a liquid by a liquid discharge apparatus, the liquid discharge apparatus includes a substrate having a pressure chamber, a nozzle to discharge the liquid in the pressure chamber, an actuator including a piezoelectric body to discharge the liquid from the nozzle to form a liquid droplet, a diaphragm holding the actuator, and a signal generator. The liquid discharge apparatus changes a position of the diaphragm to drive the nozzle to discharge the liquid. A unit pulse is a pulse having the same start electric potential and end electric potential to form one liquid droplet. The method includes generating a drive signal in which multiple unit pulses are continuous by the signal generator, and changing the amount of liquid droplets to be output according to the number of unit pulses.

In other words, a liquid discharge method includes generating a drive signal including multiple unit pulses, applying the multiple unit pulses of the drive signal to an actuator of a liquid discharge head to discharge multiple liquid droplets from a nozzle of the liquid discharge head and merge the multiple liquid droplets to form one liquid droplet, and varying a number of the multiple unit pulses continuously applied to the actuator to vary an amount of the one liquid droplet discharged from the nozzle. Each of the multiple unit pulses has a start electric potential and an end electric potential equal to the start electric potential

### Aspect 11

A liquid discharge head includes a substrate having a pressure chamber, a nozzle to discharge a liquid in the pressure chamber, an actuator including a piezoelectric body to discharge the liquid from the nozzle to form a liquid droplet, a diaphragm holding the actuator, and a signal generator. The liquid discharge apparatus changes a position of the diaphragm to drive the nozzle to discharge the liquid. A unit pulse is a pulse having the same start electric potential and end electric potential to form one liquid droplet. The signal generator generates a drive signal including continuous multiple unit pulses. The signal generator changes the amount of liquid droplets to be output according to the number of unit pulses.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium also includes a storage medium for storing processor readable code such as a floppy disk, a hard disk, a compact disc read-only memory (CD-ROM), a magnetic tape device, or a solid state memory device.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality.

Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

This patent application is based on and claims priority to Japanese Patent Application Nos. 2023-031056, filed on Mar. 1, 2023, and 2024-004712, filed on Jan. 16, 2024, in the Japan Patent Office, the entire disclosure of each of which is hereby incorporated by reference herein.

### REFERENCE SIGNS LIST

1 Liquid discharge head
2 Nozzle
3 Common liquid chamber
4 Pressurization chamber (individual liquid chamber)
5 Piezoelectric element
6 Electrical connection pad
51 First electrode (lower electrode)
52 Piezoelectric film (piezoelectric body)
53 Second electrode (upper electrode)
100: Channel substrate
101 Drive circuit
102 Wiring
103 Vibrating film (diaphragm)
110 Actuator forming layer
111: Nozzle forming portion
120 Frame

1. A liquid discharge apparatus comprising:
a substrate including a pressure chamber;
an actuator section including:
a nozzle section including nozzle from which a liquid in the pressure chamber is dischargeable; and
an actuator including an annular piezoelectric body disposed around the nozzle; and
a diaphragm holding the actuator; and
a signal generator configured to:
generate a drive signal including multiple unit pulses in a predetermined period, each of the multiple unit pulses including a start electric potential and an end electric potential equal to the start electric potential;
apply the multiple unit pulses of the drive signal to the actuator to vibrate the actuator section to discharge multiple liquid droplets from the nozzle and merge the multiple liquid droplets to form one liquid droplet; and
vary a number of the multiple unit pulses continuously applied to the actuator to vary an amount of the one liquid droplet discharged from the nozzle.

2. The liquid discharge apparatus according to claim 1, wherein:
the signal generator generates the drive signal that changes between a positive electric potential and a negative electric potential.

3. The liquid discharge apparatus according to claim 1, wherein:
the signal generator generates the drive signal that changes within a positive electric potential, and
the drive signal has the start electric potential and the end electric potential each of which is the positive electric potential.

4. The liquid discharge apparatus according to claim 1, wherein:
the signal generator generates the drive signal that changes within a negative electric potential, and
the drive signal has the start electric potential and the end electric potential each of which is the negative electric potential.

5. The liquid discharge apparatus according to claim 1, wherein:
the multiple unit pulses include one or more unit pulses including different amplitudes.

6. The liquid discharge apparatus according to claim 1, wherein the signal generator generates the drive signal including:
a rising edge to displace the diaphragm toward the pressure chamber to decrease a volume of the pressure chamber to discharge the liquid from the nozzle; and
a falling edge to displace the diaphragm away from the pressure chamber to increase the volume of the pressure chamber.

7. The liquid discharge apparatus according to claim 6, wherein:
each of the multiple unit pulses is a combination of two pulses including amplitudes in opposite directions,
the signal generator generates the drive signal that changes between a positive electric potential and a negative electric potential, the drive signal including:
the start electric potential and the end electric potential each of which is equal to 0 V at which the diaphragm is at a neutral position; and
the rising edge rising from the negative electric potential to the positive electric potential to discharge the liquid from the nozzle.

8. The liquid discharge apparatus according to claim 6, wherein:
each of the multiple unit pulses is a combination of two pulses including amplitudes in opposite directions,
the signal generator generates the drive signal that changes within a positive electric potential, the drive signal including:
the start electric potential and the end electric potential each of which is the positive electric potential;
the falling edge to displace the diaphragm to a neutral position; and
the rising edge to displace the diaphragm from the neutral position toward the pressure chamber to discharge the liquid from the nozzle.

9. The liquid discharge apparatus according to claim 6, wherein:
each of the multiple unit pulses is a combination of two pulses including amplitudes in opposite directions,
the signal generator generates the drive signal that changes within a negative electric potential, the drive signal including:
the start electric potential and the end electric potential each of which is the negative electric potential;
the rising edge to displace the diaphragm to a neutral position; and
the falling edge and another rising edge after the falling edge to displace the diaphragm to the neutral position to discharge the liquid from the nozzle.

10. The liquid discharge apparatus according to claim 1, wherein:
the number of the multiple unit pulses is five or more, and
the multiple unit pulses are continuous.

11. The liquid discharge apparatus according to claim 1, wherein:
the signal generator varies the number of the multiple unit pulses to vary the amount of the one liquid droplet to five or more times an amount of one of the multiple liquid droplets.

12. A liquid discharge method comprising:
generating a drive signal including multiple unit pulses, each of the multiple unit pulses including a start electric potential and an end electric potential equal to the start electric potential;
applying the multiple unit pulses of the drive signal to an actuator of a liquid discharge head to discharge multiple liquid droplets from a nozzle of the liquid discharge head and merge the multiple liquid droplets to form one liquid droplet; and
varying a number of the multiple unit pulses continuously applied to the actuator to vary an amount of the one liquid droplet discharged from the nozzle.

13. The liquid discharge apparatus according to claim 1, wherein:
the actuator section includes an actuator layer.
